(19) United States
(12) Patent Application Publication
(10) Pub. No.: US 2024/0110413 A1
(43) Pub. Date: Apr. 4, 2024

(54) LOCK HOLDER

(71) Applicant: Minebea AccessSolutions France S.A.S., Alfortville (FR)

(72) Inventors: Francois DEBROUCKE, Abbeville (FR); Laurent DURIEZ, Abbeville (FR); Robin DUVAUCHELLE, Abbeville (FR)

(21) Appl. No.: 18/477,643

(22) Filed: Sep. 29, 2023

(30) Foreign Application Priority Data
Sep. 30, 2022 (DE) 10 2022 125 412.7

(51) Int. Cl. E05B 85/04

(52) U.S. Cl. CPC E05B 85/04

(57) ABSTRACT

A lock holder for a motor vehicle lock, wherein the lock holder comprises of a carrier plate and a shackle and the shackle has a U-shaped geometry with two legs and a connecting web, wherein the shackle has different cross sections and at least a part of a leg has a circular cross section in which a part of a rotary latch can engage, wherein a stop is arranged at the open end of the shackle, the stop connecting the two legs of the shackle with each other.

### TECHNICAL FIELD

The present disclosure relates to a lock holder for a motor vehicle lock, wherein the lock holder consists of a carrier plate and a shackle, and the shackle has a U-shaped geometry with two legs and a connecting web, wherein the shackle has different cross sections and at least part of a leg has a circular cross section in which a part of a rotary latch can engage.

### BACKGROUND

In the prior art, EP 2 031 158 A1, for example, discloses a one-piece lock holder for a motor vehicle locking system in the form of a solid component having different cross sectional thicknesses, wherein the web has an approximately rectangular cross sectional shape with flattened sides and a cross sectional area that increases toward the base.

A drawback of this lock holder is its one-piece structure, for which reason for different lock holders different tools are necessary for the manufacture of the various lock holders. In the case of cold forming, a press with the respective molds for the different lock holders may be required, which makes the manufacture very complicated and expensive.

It is therefore the object of the present disclosure to remove the known drawbacks and in this way to improve the known lock holders.

### SUMMARY

In a lock holder of the kind mentioned at the outset, this object is achieved in that a stop is arranged at the open end of the shackle, the stop connecting the two legs of the shackle with each other. In this way, a very high stiffness of the shackle is achieved, and the shackle or the lock holder will thus not be deformed even under very high loads, such as, for example, in the event of a side impact, and can reliably hold the vehicle door closed.

In a further configuration, the stop projects beyond the two legs. This provides a larger stop surface for the shackle, and a deformation of the carrier plate cannot occur.

In a further configuration, at least one mounting portion is arranged below the stop. The mounting portion may have a circular, oval or polygonal cross-section. The mounting portion can have different cross sections, wherein e.g. the mounting portion has a larger cross sectional area on its face side than the areas adjoining it. In this way, it can be ensured that the mounting portion cannot become detached from the carrier plate.

In a further configuration, the stop has a larger cross sectional area than the connecting web. This enables the lock holder to withstand highest mechanical loads without a component failure occurring. Furthermore, this allows the geometry of the lock holder to be designed freely. The lock holder or the shackle may have an angular geometry, e.g. a rectangular geometry or a trapezoidal geometry. To save weight, the stop may include cutouts. These cutouts may be circular or polygonal cutouts. Furthermore, the cutouts may also be thin portions, wherein in the area of the thin portions the cross sectional area is smaller than in neighboring areas.

In a further configuration, at least one stiffening strut is arranged between the legs and/or between the stop and at least one leg. This allows the stop to have a smaller cross sectional area, and a further weight optimization as well as a better geometry adjusted to the load can be selected.

In a further configuration, the shackle and the stop are formed in one piece. In addition, the at least one stiffening strut may also be designed in one piece with the shackle and the stop. As a result, the component is less prone to failure than in a two-piece configuration and has greater strength.

In a further configuration, the carrier plate has two mounting holes and at least one connecting hole for receiving the mounting portion. The two mounting holes serve to attach the carrier plate to a structural component of the motor vehicle, such as, for example, the B-pillar or the C-pillar. The connecting hole can have the same geometry as the mounting portion. In the case of an oval or polygonal geometry of the mounting portion and of the at least one connecting hole, this can provide an orientation aid for the assembly of the lock holder, as a result of which the shackle and the carrier plate always have the correct orientation during installation.

Further provided is a method of manufacturing a lock holder for a motor vehicle lock, wherein the lock holder consists of a carrier plate and a shackle, and the shackle has a U-shaped geometry with two legs and a connecting web, wherein the shackle has different cross sections and at least part of one leg has a circular cross section, in which a part of a rotary latch can engage, wherein the shackle is cut from a metal plate and subsequently the circular cross section is pressed. The plate thickness may correspond to the component thickness, e.g. of the shackle and/or the stop.

The shackle and the stop are cut from the metal plate using a cutting method, such as, for example, gas cutting, plasma cutting, thin cutting or laser cutting, and subsequently the circular cross section is e.g. shaped by a cold forming process, such as, for example, a pressing process. Due to the use of a cutting process, a high degree of freedom in the geometric design is ensured, and a multitude of different lock holders can be produced with one tool without preparing a special mold for each lock holder. Furthermore, the two-part nature of the lock holder allows a modular structure so that, for example, the carrier plate always has the same geometry and/or the same structure and only the shackle has to be adapted to different vehicles.

### BRIEF DESCRIPTION OF THE DRAWINGS

Further features and advantages of the invention will be apparent from the description below and from the accompanying drawings, to which reference is made in the following and in which:

FIG. 1 shows a perspective view of a lock holder according to the disclosure;

FIG. 2 shows a perspective view of the shackle, the stop and the mounting portion;

FIG. 3 shows a further perspective view of the shackle, the stop, the mounting portion and the carrier plate;

FIG. 4 shows a further perspective view of the lock holder with an impact protection; and

FIG. 5 shows a schematic flow chart for the manufacture of a lock holder.

### DETAILED DESCRIPTION

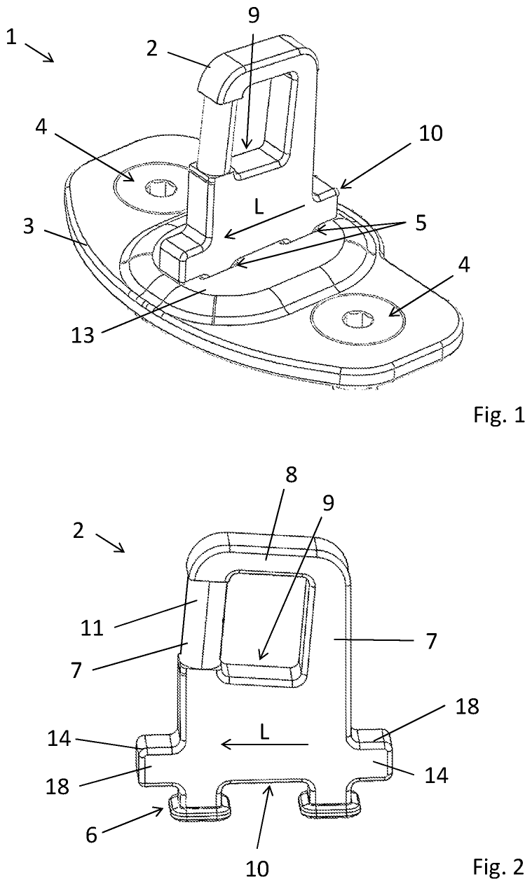

FIG. 1 shows a perspective view of a lock holder 1 according to the disclosure for a motor vehicle, the lock holder 1 consisting of a shackle 2 and a carrier plate 3. The carrier plate has two mounting holes 4 and two connecting holes 5. The two mounting holes 4 serve to mount the carrier plate 3 to a structural component of the motor vehicle, such as the B-pillar or C-pillar, for example. The connecting holes 5 may have the same geometry as a mounting portion 6 of the shackle 2. When the mounting portion 6 and the connecting holes 5 have an oval or polygonal geometry, this can provide an orientation aid for the assembly of the lock holder 1, resulting in the shackle 2 and the carrier plate 3 always having the correct orientation during installation.

The carrier plate 3 may include a raised portion 13 which, for one thing, additionally stiffens the carrier plate 3 and, for another, forms an area in which the shackle 2 is received. The raised portion 13 can be formed from the flat carrier plate 3 by, for example, a pressing process or a deep-drawing process. This provides space for a variety of fastening options for connecting the carrier plate 3 to the shackle 2, so that the carrier plate 3 rests flush against the structural component.

FIG. 2 shows the shackle 2, which consists of two legs 7 and a connecting web 8. The two legs 7 and the connecting web 8 define a U-shaped geometry. A stop 10 connecting the two legs 7 of the shackle 2 to each other is arranged at the open end 9 of the shackle 2 or at the end of the legs 7 opposite the connecting web 8. The stop 10 projects beyond the two legs 7 and thereby forms at least one wing 18, e.g. two wings 18, which project beyond the legs 7 on either side of the stop 10. As a result, the stop 10 is longer in the longitudinal direction L than the shackle 2 with the two legs 7 and the connecting web 8. The mounting portions 6 can be spaced apart from the face sides of the stop 10, so that in the case of a very high load neither the carrier plate 3 nor the shackle 2 can bend or tilt. Therefore, the wings 18 may also be referred to as torque supports 14.

Furthermore, the shackle 2 has different cross sections, at least part of one leg 7 having a circular cross section 11, in which a part of a rotary latch 12 can engage. Optionally, the remaining portions of the legs 7 and of the connecting web 8 have a polygonal cross-section. One leg 7 may be longer than the other leg 7, or the legs 7 do not extend parallel to each other.

Arranged below the stop 10 are two mounting portions 6, which protrude through the connecting holes 5 of the carrier plate 3 and are subsequently reshaped, e.g. riveted, so that a form-fitting connection is produced. The stop 10 serves as an axial stop 10 here to hold the shackle 2 in position when the form-fitting connection is established. Alternatively, an inter-material bond or a force-fitting connection may also be produced between the carrier plate 3 and the shackle 2. As illustrated in FIG. 2, the mounting portion 6 has a quadrangular cross section. After the shackle 2 has been connected, e.g. form-fittingly connected, to the carrier plate 3, the mounting portion 6 has a larger cross sectional area at its face side than the areas adjoining it. Optionally, the mounting portion 6 has different cross sections.

Optionally, the stop 10 has a larger cross sectional area than the connecting web 8. As illustrated in FIG. 2, the stop 10 is arranged immediately below the legs 7 and connects the two legs 7 to each other.

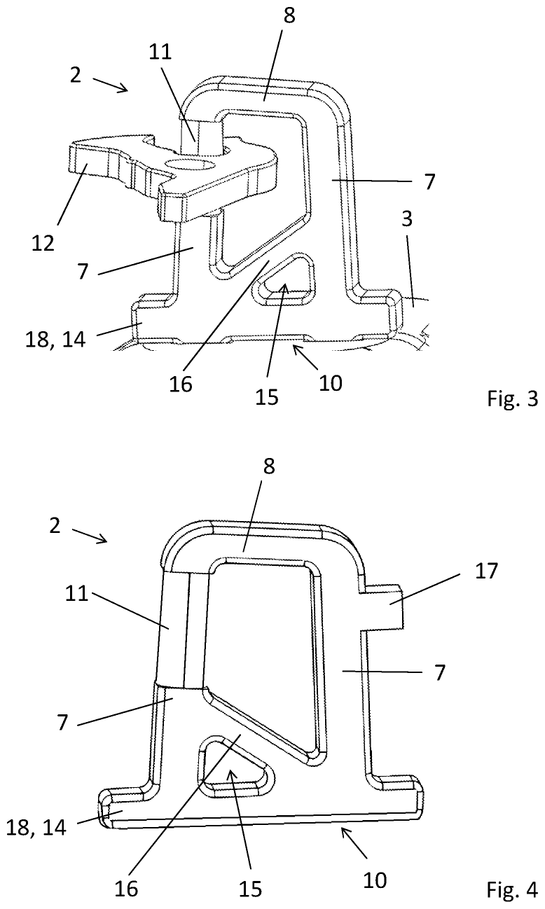

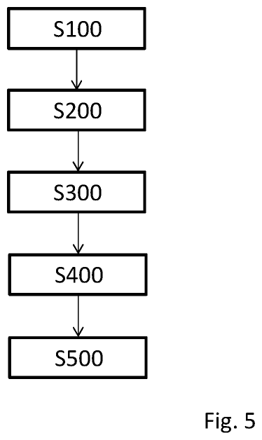

As illustrated in FIG. 3, the stop 10 may also include cutouts 15, which results in a weight saving and optimizes the shackle 2 with regard to the loads to be expected. Owing to the cutout 15, a stiffening strut 16 is formed between the legs 7 and the stop 10.

FIG. 4 shows a further perspective view of the lock holder 1, wherein, in contrast to FIGS. 1 to 3, the lock holder includes an additional impact protection 17. The impact protection 17 serves to ensure that, for example in the event of a side crash, the shackle 2 can be supported against a structural component, e.g. against the B-pillar or C-pillar. It is an option that the impact protection is arranged in the upper half, e.g. in the upper third of the shackle 2, the upper half or the upper third of the shackle 2 being connected to the connecting web 8 and thus being further away from the carrier plate 3 than the lower half or the lower third of the shackle 2. Furthermore, it is advantageous if the impact protection 17 is arranged on that leg 7 which is opposite the circular cross section 11 and projects beyond this leg 7, toward the structural component.

As illustrated in the Figures, the shackle 2, the stop 10 and the mounting portion 6 can be formed in one piece. In addition, the stiffening strut 16 and the impact protection 17 may also be designed in one piece with the shackle 2 and/or the stop 10.

To manufacture the lock holder, in a first step S100 the shackle 2 and e.g. the stop 10 and the mounting portion 6 are cut from a metal plate which corresponds to the component thickness of the shackle 2 or the stop 10. Subsequently, in step S200, the circular cross section is pressed. This is followed by step S300, in which the mounting portions 6 of the shackle 2 are inserted into the connecting holes 5 of the carrier plate 3. In step S400, the mounting portion 6 is reshaped so that a form-fitting connection is produced between the mounting portion 6 or the shackle 2 and the carrier plate 3.

The carrier plate 3 may be manufactured in a separate manufacturing process or may also be cut out of the metal plate.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A lock holder for a motor vehicle lock, comprising:
a carrier plate and a shackle, wherein the shackle has a U-shaped geometry with two legs and a connecting web, wherein the shackle has different cross sections and at least part of one leg has a circular cross section, in which a part of a rotary latch can engage, wherein a stop is arranged at the open end of the shackle, the stop connecting the two legs of the shackle with each other.

2. The lock holder according to claim 1, wherein the stop projects beyond the two legs.

3. The lock holder according to claim 1, wherein at least one mounting portion is arranged below the stop.

4. The lock holder according to claim 3, wherein the mounting portion has a circular, oval or polygonal cross section.

5. The lock holder according to claim 3, wherein the mounting portion has different cross sections.

6. The lock holder according to claim 3, wherein the mounting portion has a larger cross sectional area on its face side than the areas adjoining the mounting portion.

7. The lock holder according to claim 1, wherein the stop has a larger cross sectional area than the connecting web.

8. The lock holder according to claim 1, wherein the stop includes cutouts.

9. The lock holder according to claim 1, wherein at least one stiffening strut is arranged between the legs and/or between the stop and at least one leg.

10. The lock holder according to claim 1, wherein the shackle and the stop are formed in one piece.

11. The lock holder according to claim 1, wherein the carrier plate has two mounting holes and at least one connecting hole for receiving the mounting portion.

12. The lock holder according to claim 11, wherein the connecting hole has the same geometry as the mounting portion.

13. A method of manufacturing a lock holder for a motor vehicle lock, wherein the lock holder comprises of a carrier plate and a shackle, and the shackle has a U-shaped geometry with two legs and a connecting web, wherein the shackle has different cross sections and at least part of one leg has a circular cross section, in which a part of a rotary latch can engage, wherein the shackle is cut from a metal plate and subsequently the circular cross section is pressed.
